(19) United States
(12) Patent Application Publication
(10) Pub. No.: US 2018/0294500 A1
(43) Pub. Date: Oct. 11, 2018

(54) METHOD FOR REDUCING HALOGEN ION CONTAMINANT IN SOLID POLYMER ELECTROLYTE FUEL CELL

(71) Applicants: Daimler AG, Stuttgart (DE); Ford Motor Company, Dearborn, MI (US)

(72) Inventors: Yunsong Yang, Surrey (CA); Yuquan Zou, Surrey (CA); Keping Wang, New Westminster (CA); Carmen Chuy, Burnaby (CA)

(21) Appl. No.: 15/927,199

(22) Filed: Mar. 21, 2018

Related U.S. Application Data
(60) Provisional application No. 62/483,352, filed on Apr. 8, 2017.

(51) Int. Cl. H01M 8/1086; H01M 8/1046; H01M 8/1004

(52) U.S. Cl. CPC H01M 8/1086; H01M 2008/1095; H01M 8/1004; H01M 8/1046

(57) ABSTRACT

A method is disclosed for improving the durability of membrane electrode assemblies in solid polymer electrolyte fuel cells by reducing the amount of halogen ion contaminants present. Silver carbonate is dissolved in an ionomer dispersion and incorporated into an appropriate component in the fuel cell where it reacts with halogen ion present to form silver halides. The component is then exposed to a suitable light source that decomposes the halide into halogen gas which is then removed prior to final assembly of the fuel cell.

### BACKGROUND

### Field of the Invention

This invention relates to methods for improving the durability of membrane electrode assemblies in solid polymer electrolyte fuel cells by reducing the amount of contaminants present. In particular, it relates to reducing the amount of halogen ion present.

### Description of the Related Art

Fuel cells continue to be the subject of sustained research and development effort because of the energy efficiency and environmental benefits they can potentially provide. Solid polymer electrolyte fuel cells show particular potential for use as power supplies in traction applications, e.g. automotive. However, various challenges remain in obtaining desired performance and cost targets before fuel cells are widely adopted for automotive applications in particular.

Solid polymer electrolyte fuel cells (also known as proton exchange membrane fuel cells) convert reactants, namely fuel (e.g. hydrogen) and oxidant (e.g. oxygen or air), to generate electric power. They generally employ a proton conducting, solid polymer membrane electrolyte between two electrodes, namely a cathode and an anode. Appropriate catalyst compositions (typically supported platinum or platinum alloy compositions) are employed at each electrode to increase the reaction rate. A structure comprising a membrane electrolyte sandwiched between these two electrodes is known as a membrane electrode assembly (MEA). Porous gas diffusion layers (GDLs) are usually employed adjacent the two electrodes to assist in diffusing the reactant gases evenly to the electrodes. Further, an anode flow field plate and a cathode flow field plate, each comprising numerous fluid distribution channels for the reactants, are provided adjacent the anode and cathode GDLs respectively to distribute reactants to the respective electrodes and to remove by-products of the electrochemical reactions taking place within the fuel cell.

Water is the primary by-product in a cell operating on hydrogen and air reactants. Because the output voltage of a single cell is of order of 1V, a plurality of cells is usually stacked together in series for commercial applications. In such a stack, the anode flow field plate of one cell is thus adjacent to the cathode flow field plate of the adjacent cell. For assembly purposes, a set of anode flow field plates is often bonded to a corresponding set of cathode flow field plates prior to assembling the stack. A bonded pair of an anode and a cathode flow field plate is known as a bipolar plate assembly. Fuel cell stacks can be further connected in arrays of interconnected stacks in series and/or parallel for use in automotive applications and the like.

MEA durability is one of the most important issues now for the development of fuel cell systems in either stationary or transportation applications. For automotive applications, an MEA is required to demonstrate durability of about 6,000 hours.

In such cells, the membrane electrolyte serves as a separator to prevent mixing of reactant gases and as an electrolyte for transporting protons from anode to cathode. Perfluorosulfonic acid (PFSA) ionomer, e.g., Nafion®, has been the material of choice to date and the technology standard for membranes. Nafion® consists of a perfluorinated backbone that bears pendent vinyl ether side chains, terminating with SO₃H groups. Hydrocarbon ionomers are also being considered as a membrane electrolyte material and have been receiving much attention in recent years.

Halogenated intermediates and precursors have been widely used in the synthesis of PFSA ionomer and in the synthesis of platinum nano-particle size catalysts for such fuel cells. However, as disclosed in Electrochimica Acta 52(2007): 7444-7552, the presence of halogen ions (Cl⁻ or Br⁻) in the fuel cell, especially chloride ions, can cause dissolution and hence degradation of the platinum catalysts even at very low levels (e.g. ˜1 ppm) by forming (PtCl₄)²⁻ or (PtCl₆)²⁻ complexes. Further, at similar ppm levels, absorption of halogen ions on Pt catalyst can adversely impact MEA performance and durability in other ways as well. For instance, a negative kinetic effect can be seen on the catalyst (e.g. chloride contamination on the order of 4 ppm resulted in a fuel cell voltage loss of circa 50 mV; Journal of Electroanalytical Chemistry 508 (2001) 41-47). And there can be an enhancement in the production of hydrogen peroxide, especially on the anode side of the cell (up to circa 20% H₂O₂ can be formed in the presence of Cl⁻; Journal of Electroanalytical Chemistry 508 (2001) 41-47). In turn, the decomposition of hydrogen peroxide generates free radicals which can lead to degradation of the membrane electrolyte and eventually lead to membrane cracking, thinning or forming of pinholes.

It is thus very important to eliminate halogen ions if possible from the MEA, and especially from the catalyst layers in such in fuel cells.

In US20150024293, a MEA is disclosed that includes an electrolyte membrane, an electrode catalytic layer including nanostructured elements having acicular micro structured support whiskers bearing acicular nanoscopic catalyst particles, and a GDL including a nitrogen-containing compound that includes an anionic ion-exchange group. The nitrogen-containing compound or polymer is used to arrest chloride ion present in the fuel cell. However, with this method, chloride ions remain in the GDL in the fuel cell. The chloride ions can be discharged by regenerating the MEA. The method of regenerating involves injecting alkaline solution into the fuel cell so as to contact the gas diffusion layer, discharging the solution from the fuel cell, and then repeating with injected deionized water.

In JP2008177132, an anion trapping layer containing silver metal is incorporated in the fuel cell in at least one of a GDL, a separator (or flow field plate), or a manifold for a reactant gas. The silver metal reacts with halogen ion therein and is captured in the trapping layer. The halogen however remains in a “neutralized” form as AgCl in the fuel cell.

Notwithstanding recent advances in the art, there remains a need for improved methods of eliminating halogen ions from such fuel cells and for improved durability of the MEAs. This invention fulfills these needs and provides further related advantages.

### SUMMARY

As discussed above, the durability of membrane electrode assemblies in solid polymer electrolyte fuel cells can be improved by reducing the amount of halogen ion contaminants present (e.g. chlorine ion contaminant, bromine ion contaminant). In the present invention, this is accomplished by converting halogen ion contaminant to halogen gas which is removed prior to completing assembly of the fuel cell.

A relevant solid polymer electrolyte fuel cell typically comprises an electrolyte comprising electrolyte ionomer, a cathode comprising a cathode catalyst and cathode ionomer, and an anode comprising an anode catalyst and anode ionomer. In the method of the invention, a dispersion is prepared comprising a dispersion ionomer, silver carbonate, and an aqueous solvent. The dispersion may also contain other non-aqueous solvents (e.g. an alcohol, as is typically the case in commercial dispersions). When combined in the dispersion, the dispersion ionomer reacts with the silver carbonate to form a silver containing ionomer, carbon dioxide and water. The carbon dioxide is dispersed in the ambient atmosphere and the water blends into the solvent. In one of various ways, the dispersion is then incorporated into one or more components selected from the electrolyte, the cathode, and the anode. When incorporated into the component or components, the silver cations in the silver containing ionomer naturally react with halogen ion contaminant therein to form a silver halide. At some suitable point in the method, the solvent is removed and the component is exposed to light which is capable of decomposing the silver halide into halogen and silver metal. The light exposure thus decomposes any silver halide in the component or components into halogen gas which is subsequently removed. The component or components are then suitably assembled into the fuel cell during manufacture. In the preceding, where possible certain steps may be done in any order and/or concurrently. For instance, while the light exposure step is preferably done after all the solvent is removed, in principle the light exposure step may be done concurrently with, or after partial, removal of the solvent.

There are several ways in which the dispersion may be incorporated into one or more of the components. In one embodiment, the dispersion may be applied (e.g. coated) to the component. In another embodiment, the component can be made using the dispersion. For instance, if the components include the electrolyte, the electrolyte may be made (e.g. cast) using the dispersion. Here then, the dispersion ionomer is the electrolyte ionomer. In a like manner, if the components include the cathode and/or anode electrodes, these electrodes may be made in an otherwise conventional manner but using the dispersion ionomer as the cathode and/or anode ionomer respectively.

With regards to the types of ionomers used in the invention, various combinations may be used as is desired. For instance, the dispersion ionomer, the electrolyte ionomer, the cathode ionomer, and the anode ionomer may all be the same type of ionomer. However, any combination of the preceding ionomers may be the same or different. Suitable ionomer types for the dispersion ionomer and/or the other ionomers include perfluorosulfonic acid ionomer and hydrocarbon ionomer.

The light used in the exposing step is capable of decomposing silver halide into halogen and silver metal. For instance, visible light can be suitable to decompose silver chloride and silver bromide. Ultraviolet light is also known to be suitable to decompose silver bromide.

Solid polymer electrolyte fuel cells made using the method of the invention can be distinguished by the presence of silver metal in a component selected from the electrolyte, the cathode, and the anode. Further, such fuel cells can be distinguished by components which comprise essentially no silver halide.

These and other aspects of the invention are evident upon reference to the following detailed description.

### BRIEF DESCRIPTION OF THE DRAWINGS

FIG. 1 illustrates the reactions taking place when silver carbonate is added to the ionomer dispersion used in the method of the invention.

### DETAILED DESCRIPTION

The present invention provides for improved durability of membrane electrode assemblies in solid polymer electrolyte fuel cells and stacks by reducing the amount of halogen ion contaminants present therein. Halogen ions, and especially Cl⁻, can cause dissolution of the typical Pt catalysts used in the fuel cell electrodes and thereby form PtCl₄. Significant dissolution can take place even with very low levels of halogen present. Such dissolution significantly contributes to the degradation of the electrode catalysts. For instance, in certain developmental anode catalyst material, amounts of Cl as high as several thousand ppm have been found. These amounts are significant and lead to significant dissolution of the fuel cell catalysts.

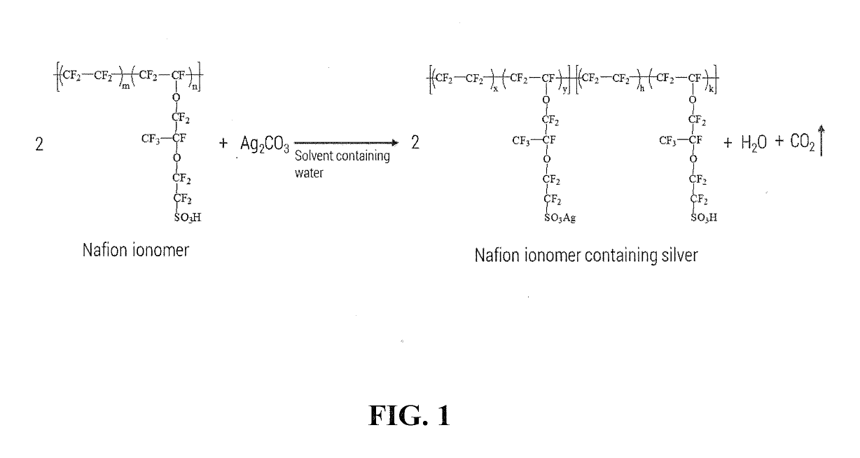

In the present invention, a source of halogen ion scavenger, specifically silver ions (Ag⁺) from silver carbonate (Ag₂CO₃), is dispersed in a water based ionomer dispersion which is further incorporated into the electrolyte and/or one or both electrodes of the fuel cell as is desired for removing contaminants. In the ionomer dispersion, the silver carbonate can desirably react with the ionomer (a strong acid), with dissociated protons (from the ionomer) and carbonate ions reacting to form carbon dioxide gas and water, and exchanging dissolved silver ions for proton in the ionomer. The carbon dioxide formed simply vents to atmosphere. This series of reactions is illustrated in FIG. 1.

In the presence of halogen ions, the silver anions in the dispersion react to form insoluble silver halide precipitates. For chloride and bromide contaminants, silver chloride and silver bromide are formed respectively. Advantageously though, in the present invention, the precipitates are exposed to a suitable light source which is capable of decomposing the halide precipitate into halogen and silver metal. For chloride contaminant, chlorine gas and silver metal are produced when AgCl is exposed to a suitable visible light source (as per the below equation).

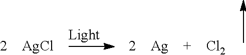

The chlorine gas is readily removed under ambient conditions. For bromide contaminant, under ambient conditions, bromine liquid and silver metal are produced when AgBr is exposed to a suitable light source (e.g. ultraviolet light, as per the below equation).

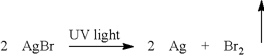

Bromine however has a relatively low boiling point of about 59° C. and thus it can also be readily removed as a gas with moderate heating, and without damaging the ionomer or other cell components.

In this way, the halogen ions present in the electrolyte and/or one or both electrodes can be removed prior to final assembly of the fuel cell. This is accomplished by incorporating a dispersion comprising silver carbonate into each desired component. The halogen ions react to form silver halide precipitate which is then decomposed to produce halogen that can readily be removed in gaseous form.

The amount of silver carbonate to be used in the inventive method depends on how much halogen ion content may be present and how low an amount of halogen ion can be tolerated in the fuel cell. In principle though, the halogen ion content is as low as possible to avoid any impact on MEA durability. The following discussion provides guidance for determining suitable amounts of silver carbonate to use in order to achieve a desired level of halogen ion in an electrode component. For instance, based on the known solubility constant of AgCl, the concentration of Cl⁻ in a saturated AgCl solution at 25° C. is 0.443 ppm. Thus, with sufficient Ag⁺ added to match the amount of CL present, a level of 0.443 ppm of free Cl ion is obtained in the relevant component, with the remaining Cl ion tied up as solid AgCl. After removing the dispersion solvent and exposing the component to light in accordance with the inventive method, the AgCl decomposes, releasing the chloride as chlorine gas which escapes to atmosphere. However, a component level even lower than 0.443 ppm can be obtained by using an excess of Ag⁺. For instance, to achieve a level of less than 10 ppb of chloride ion in 50 g of the dry solid component (assuming the volume of dispersion is 250 mL before removing all solvent), the Cl ion concentration in the dispersion should be less than 5.64×10⁻⁸ mol/L and thus the Ag ion concentration should be more than 2.77×10⁻³ mol/L in the dispersion. In a like manner, based on the known solubility constant of AgBr, the concentration of Br⁻ in a saturated AgBr solution at 25° C. is 0.070 ppm. Thus, with sufficient Ag⁺ added to match the amount of Br⁻ present, a level of 0.070 ppm of free Br ion can be obtained in the relevant component. And further, even lower levels can be obtained using an excess of Ag⁺ ion.

The dispersion comprising the silver carbonate can be incorporated into the desired component using various conventional methods. For instance, the dispersion can be applied (e.g. by spray or roll coating) to the component after the usual fabrication of the component. Alternatively, the dispersion might instead be suitably incorporated during the usual fabrication of the component. Because the electrolyte contains electrolyte ionomer and the cathode and anode electrodes usually contain ionomer (cathode ionomer and anode ionomer respectively), silver carbonate might simply be incorporated appropriately into the dispersions used to form the ionomers appearing in these components. Thus, the dispersion ionomers used in the invention may include any or all of the electrolyte, cathode, and anode ionomer types. These types potentially include perfluorosulfonic acid ionomers, hydrocarbon ionomers, and any other ionomers suitable for use in solid polymer electrolyte fuel cells. Although different types of ionomer may be used in each of these components, often the same type of ionomer is used in a given fuel cell construction.

In the general method of the invention, once the incorporated silver carbonate can react with halogen ion contaminants, it is then possible to remove halogen via exposure to a suitable light source. Thus, some variation in the order of certain steps in the method is possible and certain steps may be done concurrently. For instance, consideration may be given to exposing the component to the light source before all the solvent has been removed. And further, halogen may thus be removed (e.g. as a gas) also before all the solvent is removed. Further still, the exposing step may be done on individual components or for instance continuously on moving webs comprising the components.

During various stages of the fabrication process, silver carbonate and silver halides may be found in the relevant fuel cell components (electrolyte and electrodes). However, if the relevant reactions are allowed to go to completion—including the decomposition reactions resulting from the exposure to light, once assembly of the fuel cell is complete, there may be essentially no silver halide remaining in the fuel cell. In such embodiments, this can be a distinguishing feature of the present invention. (Note however that, as discussed below, AgCl may be created again in very small amounts via reaction with PtCl₄.)

By incorporating silver carbonate into halogen contaminated fuel cell components in this way, the present invention advantageously eliminates halogen ions, and particularly chloride ions, and thereby slows down the degradation of the catalysts and membrane electrolyte in the cell. In turn, this improves cell performance and durability. The method is relatively simple and introduces little in the way of additional steps in fuel cell fabrication. The carbonate counter ion in the incorporated silver carbonate is benign to the cell and further, as explained above, can be eliminated as carbon dioxide anyway during fabrication.

The metallic silver that is ultimately formed in the cell components provides additional benefits for the inventive method. Silver metal is a free radical scavenger which desirably decomposes any hydrogen peroxide which may be present in the fuel cell. In turn, decomposing any hydrogen peroxide present further slows down catalyst degradation and improves durability of the membrane electrode assembly in the fuel cell. Further still, silver metal is the only metal which can readily reduce PtCl₄ to Pt. Undesirably, PtCl₄ may be formed by inadvertent dissolution of Pt catalysts in the fuel cell. The small amounts of silver present however can react with any formed PtCl₄ to form AgCl and Pt, thereby regenerating the catalyst material. This reaction is favored at a temperature of ˜27° C.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

What is claimed is:

1. A method for reducing the amount of halogen contaminant in a solid polymer electrolyte fuel cell, the fuel cell comprising an electrolyte comprising electrolyte ionomer, a cathode comprising a cathode catalyst and cathode ionomer, and an anode comprising an anode catalyst and anode ionomer, the method comprising:
preparing a dispersion comprising a dispersion ionomer, silver carbonate, and an aqueous solvent whereby the dispersion ionomer and the silver carbonate react to form a silver containing ionomer, carbon dioxide and water;
incorporating the dispersion into a component selected from the electrolyte, the cathode, and the anode whereby the silver cations in the silver containing ionomer react with halogen ion contaminant in the component to form a silver halide;
removing the solvent;
exposing the component to light capable of decomposing the silver halide into halogen and silver metal;
removing the halogen; and
assembling the component into the fuel cell.

2. The method of claim 1 wherein the halogen is chlorine or bromine.

3. The method of claim 1 wherein the incorporating step comprises applying the dispersion to the component.

4. The method of claim 1 wherein the incorporating step comprises making the component using the dispersion.

5. The method of claim 4 wherein the component is the electrolyte and the dispersion ionomer is the electrolyte ionomer.

6. The method of claim 4 wherein the component is the cathode and the dispersion ionomer is the cathode ionomer.

7. The method of claim 4 wherein the component is the anode and the dispersion ionomer is the anode ionomer.

8. The method of claim 1 wherein the dispersion ionomer, the electrolyte ionomer, the cathode ionomer, and the anode ionomer are the same type of ionomer.

9. The method of claim 1 wherein the dispersion ionomer is perfluorosulfonic acid ionomer or hydrocarbon ionomer.

10. The method of claim 1 wherein the light used in the exposing step is visible light or ultraviolet light.

11. A solid polymer electrolyte fuel cell comprising an electrolyte comprising electrolyte ionomer, a cathode comprising a cathode catalyst and cathode ionomer, and an anode comprising an anode catalyst and anode ionomer wherein the fuel cell comprises silver metal in a component selected from the electrolyte, the cathode, and the anode.

12. The fuel cell of claim 11 wherein the component comprises essentially no silver halide.
